(19) United States
(12) Patent Application Publication
(10) Pub. No.: US 2005/0161063 A1
(43) Pub. Date: Jul. 28, 2005

(54) Apparatus and method for controlling the water level in a residential dishwasher

(76) Inventor: Michael T. Clouser, Brownsburg, IN (US)

Correspondence Address: HARNESS, DICKEY & PIERCE, P.L.C., P.O. BOX 828, BLOOMFIELD HILLS, MI, 48303, US

(21) Appl. No.: 10/767,967

(22) Filed: Jan. 28, 2004

(51) Int. Cl. B08B 7/04

(52) U.S. Cl. 134/56 D; 134/58 D

(57) ABSTRACT

An apparatus for controlling the water level in a dishwasher. The apparatus comprises a heating element having a resistance adapted to change in response to a change in the water level of the dishwasher, and a data processing unit coupled to the heating element for measuring the resistance of the heating element, determining the water level based on the resistance of the heating element, and filling the dishwasher to a desired water level.

### FIELD OF THE INVENTION

The present invention relates to a method for measuring the water level in a residential dishwasher.

### BACKGROUND OF THE INVENTION

Providing and maintaining a precise water level in a dishwasher is important for many reasons, including for example, assuring that the dishwasher does not experience either an underfill or an overfill condition. The underfill condition can result in a poor wash performance. The overfill condition can cause damage to the dishwasher.

Typically, most dishwashers employ two methods for filling the dishwasher. One method is by using a timer in connection with a microprocessor that controls the operation of a water-inlet valve connected to a water supply. The timer generally opens and closes the water valve at a predetermined length of time to fill the dishwasher to a desired water level. Another method is by using a float switch device. The float switch is generally cylindrical in shape and is located inside the dishwasher at the bottom of the dishwashing tank. In operation, as the water level in the dishwasher rises, the float rises accordingly. When the float reaches a predetermined level, the float activates its switch, cutting the electricity to the water-inlet valve, thereby terminating the fill cycle. However, these two methods do not provide for the most accurate water level measurement. The timer and the float switch have a wide tolerance range due to the different water pressures experienced in every household. As a result, an accurate water level is often not obtained, thereby enabling an overfill or underfill condition to occur in the dishwasher.

Therefore, there is a need for a method for more accurately measuring the water level in a residential dishwasher independent of influences such as water pressure. In addition, there is also a need for a method for more accurately filling the dishwasher to a desired water level.

### SUMMARY OF THE INVENTION

The invention provides an apparatus for controlling the water level in a dishwasher comprising a heating element having a resistance adapted to change in response to a change in the water level of the dishwasher. A data processing unit is coupled to the heating element and measures the resistance of the heating element, determines the water level based on the resistance measurement, and fills the dishwasher to a desired water level, accordingly.

In another aspect of the invention, a method for controlling the water level in a dishwasher comprising the steps of determining a desired water level, measuring a resistance of a heating element, and filling the dishwasher to the desired water level using the resistance measurements. The water level of the dishwasher thereby corresponds to the resistance of the heating element.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is generally a schematic representation of a dishwasher according to the present invention;

FIG. 2 is a detailed view of a first configuration of a heating element used in the dishwasher according to the invention;

FIG. 3 is a flowchart illustrating the steps for operating the dishwasher including the first configuration of FIG. 2;

FIG. 4 is a detailed view of a second configuration of the heating element used in the dishwasher according to the invention; and

FIG. 5 is a flowchart illustrating steps for operating the dishwasher including the second configuration of FIG. 4.

### DETAILED DESCRIPTION OF THE PREFERRED EMBODIMENTS

The following description of the preferred embodiment is merely exemplary in nature and is in no way intended to limit the invention, its application, or uses.

The present invention provides a dishwashing system that employs an apparatus and method for measuring the water level in a residential dishwasher and accurately filling the dishwasher to a desired water level. The apparatus employs a main control panel for selecting a wash cycle, a water valve for filling the dishwasher based on the selected wash cycle, a heating element adapted to change in resistance in response to the water level in the dishwasher, and a data processing unit for determining a fill rate and measuring a precise water level. The method includes using the heating element of the dishwasher and directly measuring the resistance of the heating element to determine the fill rate for filling the dishwasher to a desired water level and to measure the precise water level.

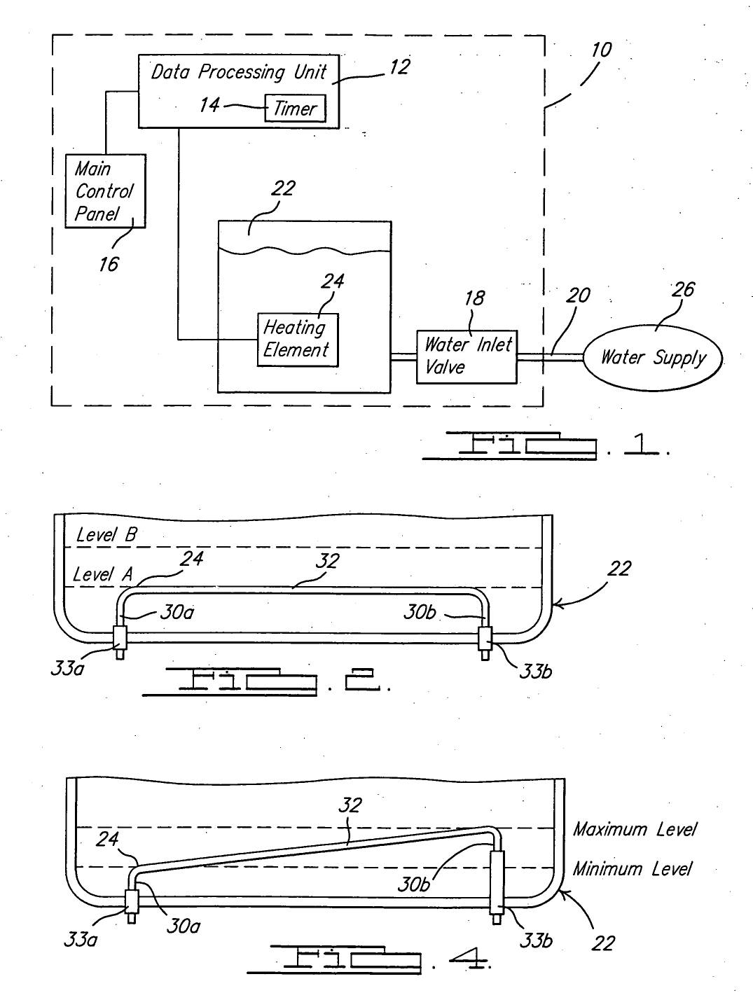

FIG. 1 is a simplified schematic representation of a dishwasher 10 according to the present invention. At the outset, the schematic depicts the major components of the dishwasher 10. Other known components that serve to complete the dishwasher, however, are not shown, such as, for example, a motor and pump assembly for re-circulating the water for washing or rinsing, and draining the dishwasher.

It should be readily understood that the dishwasher 10 according to the present invention does not include a float switch that is typically employed in a current dishwasher to fill the dishwasher to the desired water level. Rather, a fill rate is calculated by measuring the resistance of the heating element itself, and the calculated fill rate is used to fill the dishwasher to the desired water level.

The dishwasher 10 generally comprises a data processing unit 12 with a timer 14, a main control panel 16, a water-inlet valve 18, a conduit 20, a dishwashing chamber 22, and a heating element 24. The data processing unit 12 is in communication with the main control panel 16, the water-inlet valve 18, and the heating element 24. Specifically, the data processing unit 12 performs the functions of receiving an input and sending an output to either one of the components. It should be understood that the data processing unit 12 can be any type of commercially available processor for executing instructions and processing data.

The timer 14 is generally located behind the main control panel 16 and is connected with the data processing unit 12. The timer 14 can be an electronic device capable of providing a digital signal to the data processing unit 12. The timer 14 is used as a standard counting device. The timer 14 helps provide power to all of the dishwasher components at a pre-set time and for a pre-set period of time as computed by the data processing unit 12.

The user operated main control panel 16 is generally located at the front top of the dishwasher. The main control panel 16 includes one or more selector switches. The switches provide options among wash cycles, drying cycles (heat or no heat), temperatures for the wash or rinse, and so on. The wash cycle selected from the switches of the panel 16 is used to calculate the pre-set time for the timer 14. These switches may include, for example, an option for a heavy, medium, and a light cycle. For instance, when the user selects the heavy cycle, the data processing unit 12 automatically determines the desired water level. The desired water level varies according to the selected wash cycle. Each wash cycle can have a different water level. It should be understood that the main control panel 16 may include a number of options that can be considered as a factor in determining the desired water level.

The water-inlet valve 18 is generally located at the bottom left or right of the dishwasher and is in communication with the data processing unit 12. The water-inlet valve 18 is connected to a water supply 26 by conduit 20 to allow water to flow into the dishwashing chamber 22 for the selected wash cycle. The water-inlet valve 18 is typically attached to a hot-water supply line of the water supply 26. The timer 14 and the data processing unit 12 control the water-inlet valve 18. The timer 14 turns the water-inlet valve 18 on and off for a length of time calculated by the data processing unit 12. Specifically, the timer 14 opens and closes the water-inlet valve 18 for the calculated length of time to allow water into the dishwashing chamber 22. The water-inlet valve 18 closes when the timer 14 cuts off the flow of power to the water-inlet valve 18. The timer 14 keeps the water-inlet valve 18 open for the length of time to fill the dishwashing chamber 22 to the desired water level.

The dishwashing chamber 22 is located within the body of the dishwasher 10. The dishwashing chamber 22 is the region where the washing and rinsing takes place. The dishwashing chamber 22 includes a number of components that are not shown, such as supporting racks for loading dishes, a pump assembly and spray arms for spraying water onto the dishes, a soap dispenser for providing soap, a drain and a solenoid drain valve for draining the wash water through a hose and out to a plumbing waste system. The volume of water the dishwashing chamber 22 can hold is pre-stored in the data processing unit 12 and is used to calculate a fill rate. It should be understood that the dishwashing chamber 22 can be any size and shape suitable for the different washing cycles.

The heating element 24 is located within the body of the dishwashing chamber 22 and is adapted to be submerged in water. The heating element 24 is generally located in a sump area of the dishwashing chamber 22. The heating element 24 is made of wire wrapped around a core and is nearly entirely resistive. As such, the resistance of the heating element 24 changes in response to the water level. The heating element 24 essentially acts as a resistor with positive temperature coefficient (PTC) characteristics and a sensor. The data processing unit 12 enables the heating element 24 to turn on and off for a calculated length of time.

FIG. 2 is a detailed view of a first configuration of the heating element 24 used in the dishwasher 10. The heating element 24 includes end positions 30a, 30b and a main body 32. The main body 32 is coupled between end positions 30a, 30b, which are coupled to the sump area of the dishwashing chamber 22. The end positions 30a, 30b include insulating couplers 33a, 33b attached on the ends of the end positions 30a, 30b in order to connect the heating element 24 to the bottom of the dishwashing chamber 22, while insulating the heating element 24 from the chamber 22. As such, the end positions 30a, 30b are slightly above the bottom surface of the chamber 22. In this configuration, as water is introduced in the dishwashing chamber 22, end positions 30a, 30b are first to contact the water. When water contacts the end position 30a, 30b, a resistance between the end positions 30a, 30b is measured. The resistance change between the end positions 30a, 30b is relatively small and steady as the water moves along the end positions 30a, 30b towards the main body 32. The resistance of the heating element 24 changes dramatically when the water level reaches the main body 32 of the heating element 24. Once water reaches the main body 32 of the heating element 24, the fill rate can be computed by the data processing unit 12.

The data processing unit 12 determines the fill rate for the dishwasher 10 by measuring the length of time elapsed from the time the end positions 30a, 30b are exposed to water till the time the main body 32 is submerged with water. This is accomplished with the use of the timer 14. Specifically, the timer 14 begins counting as soon as water is introduced to the dishwashing chamber 22 and contacts end positions 30a, 30b. The data processing unit 12 measures the resistance of the heating element 24 when the timer 14 is actuated to begin counting. The data processing unit 12 continually measures the resistance of the heating element 24 until the water level reaches the main body 32 of the heating element 24. At this point, a dramatic change of resistance is measured. Once the water reaches the main body 32 of the heating element 24, the data processing unit 12 computes the fill rate. The fill rate is the volume of water over time. The volume of water up to the main body 32 of the heating element 24 is pre-stored in the data processing unit 12. The known volume can vary depending where the main body 32 is positioned relative to the bottom surface of the chamber 22. The main body 32 can be positioned at any convenient level of the dishwashing chamber 22.

The data processing unit 12 also computes a water-valve turn-off time. The valve turn-off time is used by the timer to keep the water-inlet valve 18 open for the remaining time in which to fill the dishwasher to the desired water level. The known water level is referred to as level A, where the main body 32 of the heating element 24 is positioned. The desired water level is shown as level B. The desired water level B is reached by using the fill rate to compute the water-valve turn off time. Specifically, the data processing unit determines the remaining volume of water needed to fill the dishwashing chamber 22 from level A to level B. The data processing system uses the water-inlet valve turn off time to fill the chamber 22 to the desired water level. This results in a controlled amount of water in the dishwasher 10.

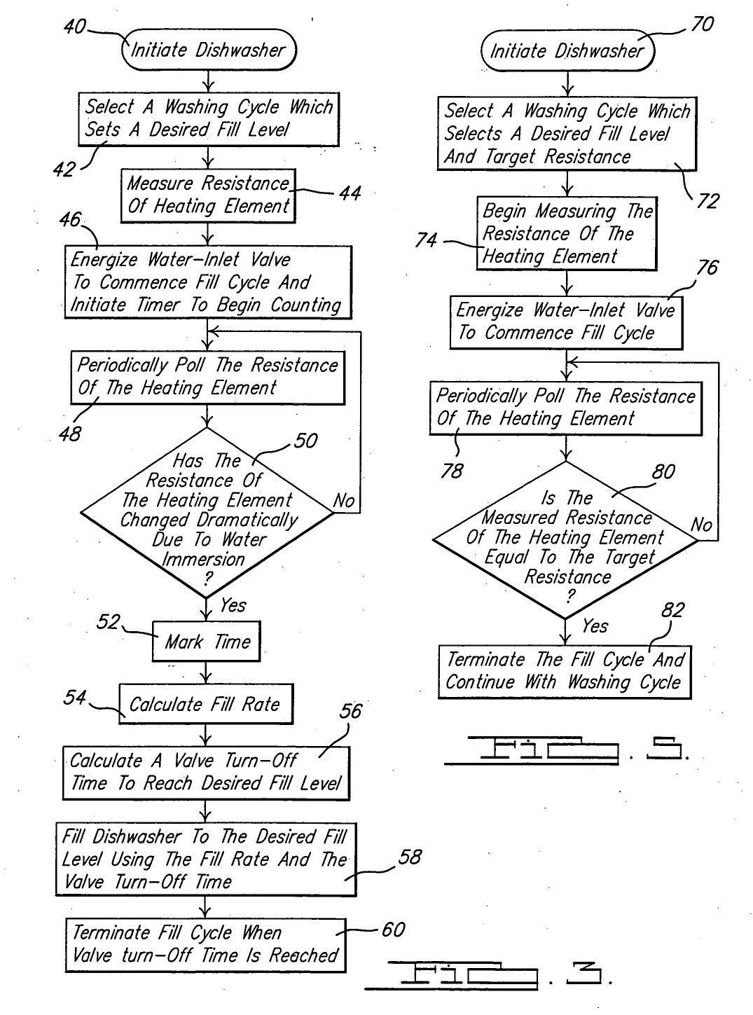

FIG. 3 is a flowchart illustrating steps for operating the dishwasher 10 including the first configuration of the heating element 24 in FIG. 2. Dishwasher 10 operation is initiated at 40. At 42, a washing cycle is selected and a desired water level for the selected wash cycle is set. At 44, the resistance of the heating element 24 is measured. Next, at 46, the water-inlet valve 18 is energized to commence the fill cycle and to initiate timer 14 to begin counting. At 48, the resistance of the heating element 24 is measured at repeated intervals. At 50, the data processing unit 12 determines whether the resistance of the heating element 24 has changed dramatically, indicating immersion of the heating element in water. If the answer is no, then repeat 48. If the answer is yes, then the heating element 24 experiences a change in the order of magnitude of resistance so continue to step 52. At 52, time is taken from timer 14 and marked by the data processing unit 12. Then the fill rate is calculated at 54. At 56, a valve turn-off time for reaching the desired fill level is calculated. At 58, the dishwasher is filled to the desired fill level using the calculated fill rate and the valve turn-off time. Finally, the fill cycle is terminated when the valve turn-off time has elapsed at 60.

FIG. 4 is a detailed view of a second configuration of the heating element 24 used in the dishwasher 10 according to the invention. In this configuration, end position 30a is shorter in length than end position 30b. As such, the mean body 32 is at an angle greater than zero degrees between the end positions 30a, 30b. A minimum and a maximum fill level correspond to the height of the end positions 30a, 30b, respectively. The minimum fill level is near the upper surface of end position 30a. The maximum fill level is near the upper surface of end position 30b. In this setup, it is envisioned that the resistance of the heating element 24 is continuously variable along the length of the main body 32 such that as the water level increases between the minimum fill level to the maximum fill level, a change in resistance occurs. The resistance of heating element 24 correlates to a predetermined water level. Therefore, the resistance measurements are used to terminate the water fill at the desired water level between the minimum and maximum water level. It is envisioned that the more shallow the angle between the minimum fill level end position 30a and the maximum fill level end position 30b, the more precise the water level control can be.

With this configuration, the water level can be controlled anywhere between the minimum fill level to the maximum fill level because the water level can be measured anywhere between the minimum and maximum fill levels. The minimum and maximum levels are pre-selected according to the wash cycles of the dishwasher 10. The data processing unit 12 is operative to interpret the resistance of the heating element 24 as a specific water level and terminate the operation of the water-inlet valve 18 at the desired level.

FIG. 5 is a flowchart illustrating steps for operating the dishwasher 10 including the second configuration of the heating element 24 in FIG. 4. Dishwasher operation is initiated at 70. At 72, a washing cycle is selected and a desired fill level and a target resistance is set. The target resistance corresponds to the desired fill level. Next, the resistance of the heating element 24 is measured at 74. At 76, the water-inlet valve is energized to commence the fill cycle. Then the resistance of the heating element 24 is measured at repeated intervals at 78. At 80, the data processing unit 12 determines if the measured resistance of the heating element 24 is equal to the target resistance. If the answer is no, then 78 is repeated. If the answer is yes, the target resistance has been reached and the desired level has also respectively been reached. At 82, terminate the fill cycle and continue with the washing cycle.

It should be understood that the method for measuring the resistance of a heating element to determine the water level can be employed to other systems, such as, for example, a washing machine. The present invention provides a method for accurately filling a dishwasher and measuring the water level of the dishwasher.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and the following claims.

1. A dishwasher having an apparatus for controlling the water level in the dishwasher comprising:
a heating element having a resistance adapted to change in response to a change in the water level of the dishwasher; and
a data processing unit coupled to the heating element for measuring the resistance of the heating element, determining the water level based on the resistance of the heating element, and filling the dishwasher to a desired water level.

2. The apparatus of claim 1, further comprising a control panel having a plurality of washing cycles.

3. The apparatus of claim 2, wherein the selection of at least one of the plurality of washing cycles sets the desired water level.

4. The apparatus of claim 1, wherein the water level corresponds to the resistance of the heating element.

5. The apparatus of claim 1, wherein the data processing unit determines a fill rate using the resistance measurements of the heating element and fills the dishwasher to the desired water level.

6. The apparatus of claim 1, further comprising a water valve for supplying water to the dishwasher.

7. The apparatus of claim 6, wherein the data processing unit controls the water valve by computing a length of time to open and close the water valve in order for the dishwasher to be filled to the desired water level.

8. The apparatus of claim 1, wherein the heating element includes a main body coupled to first and second end positions, the main body positioned horizontally between the first and second end positions.

9. The apparatus of claim 8, wherein the resistance of the heating element changes when the water level rises above the first and second end positions to the main body of the heating element.

10. The apparatus of claim 1, wherein the heating element includes a main body coupled to first and second end positions, the main body positioned at an angle greater than zero degrees between the first and second end positions.

11. The apparatus of claim 10, wherein the resistance of the heating element changes when the water level rises between a minimum and maximum level.

12. A dishwasher having an apparatus for controlling the water level in the dishwasher comprising:
a control panel providing a plurality of washing cycles for setting a desired water level;
a heating element having a resistance adapted to change in response to a change in the water level of the dishwasher; and
a data processing unit coupled to the heating element and the control panel for measuring the resistance of the heating element and filling the dishwasher to the desired water level, wherein the water level correlates to the measured resistance of the heating element.

13. The apparatus of claim 12, wherein the data processing unit determines a fill rate using the resistance measurements of the heating element and fills the dishwasher to the desired water level.

14. The apparatus of claim 12, further comprising a water valve for supplying the dishwasher with water.

15. The apparatus of claim 14, wherein the data processing unit opens the water valve to fill the dishwasher to the desired water level.

16. The apparatus of claim 12, wherein the heating element includes a main body coupled to first and second end positions, the main body positioned horizontally between the first and second end positions.

17. The apparatus of claim 16, wherein the resistance of the heating element changes when the water level rises above the first and second end positions to the main body of the heating element.

18. The apparatus of claim 12, wherein the heating element includes a main body coupled to a first and second end position, the main body positioned at an angle greater than zero degrees between the first and second end positions.

19. The apparatus of claim 18, wherein the resistance of the heating element changes when the water level rises between a minimum and maximum level.

20. A dishwasher having an apparatus for controlling the water level in the dishwasher comprising:
a water valve for supplying the dishwasher with water;
a control panel providing a plurality of washing cycles for setting a desired water level;
a heating element having a resistance adapted to change in response to a change in the water level of the dishwasher; and
a data processing unit coupled to the heating element for measuring the resistance of the heating element, determining the water level based on the resistance of the heating element, computing a fill rate using the resistance measurement of the heating element, and filling the dishwasher to the desired water level.

21. The apparatus of claim 20, wherein the water level corresponds to the resistance of the heating element.

22. A method for controlling the water level in a dishwasher comprising:
determining a desired water level;
measuring a resistance of a heating element; and
filling the dishwasher to the desired water level using the resistance measurement, wherein the water level of the dishwasher corresponds to the resistance of the heating element.

23. The method of claim 22, further comprising computing a fill rate for filling the dishwasher to the desired water level.

24. The method of claim 22, further comprising:
providing water to the dishwasher through a water valve; and
computing a length of time for opening the water valve device to fill the dishwasher to the desired water level.

25. The method of claim 22, further comprising:
providing the heating element with a main body coupled to first and second end positions; and
positioning the main body horizontally between the first and second end positions.

26. The method of claim 25, further comprising changing the resistance of the heating element when the water level rises above the first and second end positions to the main body of the heating element.

27. The method of claim 22, further comprising:
providing the heating element with a main body coupled to first and second end positions; and
positioning the main body at an angle greater than zero degrees between the first and second end positions.

28. The method of claim 27, further comprising changing the resistance of the heating element when the water level rises.
